(19) United States
(12) Patent Application Publication
(10) Pub. No.: US 2008/0181754 A1
(43) Pub. Date: Jul. 31, 2008

(54) Discharge hopper and method of discharing trays, in particular shaft trays, filled with rod-shaped articles

(75) Inventors: Piotr Budny, Hamburg (DE); Thomas Muller, Hamburg (DE); Matthias Horn, Ahrensburg (DE); Michael Knabe, Geesthacht (DE); Arnd Meier, Beckdorf (DE)

Correspondence Address: VENABLE LLP, P.O. BOX 34385, WASHINGTON, DC, 20043-9998, US

(73) Assignee: Hauni Maschinenbau Ag, Hamburg (DE)

(21) Appl. No.: 12/010,992

(22) Filed: Jan. 31, 2008

(30) Foreign Application Priority Data
Jan. 31, 2007 (DE) 10 2007 005 749.2

(51) Int. Cl. B65G 65/00

(52) U.S. Cl. 414/295; 414/808

(57) ABSTRACT

A discharge hopper for a tray discharge station discharges a tray filled with rod-shaped products. A receiving chamber for the products flowing from the tray is open at the top in the direction of the tray and at the bottom is defined by a channel formed by a conveying element that carries away the products. Flow regulating elements within the receiving chamber control the flow of products within the discharge hopper. A monitoring unit is arranged and constructed for detecting the level of products within the tray. The monitoring unit is operatively connected to the flow regulating elements for individual control of the flow regulating elements.

### CROSS-REFERENCE TO RELATED APPLICATIONS

This application claims the priority of German Patent Application No. 10 2007 005 749.2, filed on Jan. 31, 2007, the subject matter of which is incorporated herein by reference.

### BACKGROUND OF THE INVENTION

The invention concerns a discharge hopper for a tray discharge station for discharging trays filled with rod-shaped products, in particular shaft trays, comprising a receiving chamber for the products flowing from the trays, the receiving chamber being open at the top in the direction of the trays and defined at the bottom by a channel-forming conveying element for carrying away the products, as well as flow regulating elements within the receiving chamber for control of the product stream within the discharge hopper. Furthermore, the invention concerns a method for the discharge of trays filled with rod-shaped products, in particular shaft trays, comprising the steps of: opening the tray or shaft tray, passing the product stream through a receiving chamber of the discharge hopper into the region of a conveying element, the product stream being regulated by flow regulating elements within the receiving chamber as well as in the region of a channel formed by the conveying element, and carrying the product stream away along the channel.

Such apparatuses and methods are used in particular in the tobacco-processing industry, in the processing of rod-shaped products. For different reasons, cigarettes, filter rods or the like are kept in containers, the so-called trays, for storage. Thereby, the containers can be designed as standard trays having a single receiving chamber for the products or as shaft trays in which the products lie in several shafts separate from each other. For further processing of the stored products, the latter are dispensed to subsequent apparatuses, e.g. packing machines or the like, or funneled into an existing mass flow. For automated delivery of the articles from the containers, usually discharge stations are available. The discharge stations comprise in a known manner a delivery means for product-filled trays, a discharge hopper, a removal device for the empty trays and a transfer device by means of which the full trays are transported from the delivery means into the region of the discharge hopper and from the discharge hopper into the region of the removal device. The transfer device can vary in construction. Widespread are pivot devices which have a receptacle for one or more trays and which are assigned a movable closure element for the open-topped trays.

The actual discharge hopper serves to continuously and uniformly carry away products flowing out of the trays when the closure element is open, via the conveying element which defines the bottom of the holding chamber of the discharge hopper, and to deliver them to the subsequent apparatuses or the like. A discharge hopper known from DE 41 18 267 A1 has a receiving chamber for receiving the products falling out of the trays. This receiving chamber is open at the top in the direction of the trays to be emptied and defined at the bottom by a conveying element. This conveying element is arranged beneath the receiving chamber in such a way that between the receiving chamber and the conveying element is formed a channel which serves to carry away the products. Within the receiving chamber are arranged several flow regulating elements. The flow regulating elements include on the one hand rods which are movable back and forth linearly or in rotation, and on the other hand shaft walls which are movable up and down. In other words, the outlet shaft-forming shaft walls as a whole are vertically displaceable in their position. To monitor the product stream within the discharge hopper, in the receiving region are arranged sensors for monitoring the level within the receiving chamber, the information detected by the sensors being used to control the conveying element formed from two discharge belts. However, this apparatus has the drawback that the discharge operation is non-uniform in spite of monitoring of the product stream within the discharge hopper. As a result, during discharge of the trays and in particular shaft trays there can be blockades in the individual vertically extending outlet shafts and/or in the horizontal channel.

### SUMMARY OF THE INVENTION

It is the object of the invention to propose an apparatus and a method for reliable and uniform discharge of product-filled trays, in particular shaft trays.

This object is achieved by an apparatus of the kind mentioned hereinbefore by the fact that the discharge hopper is assigned a monitoring means for detecting the level within the tray, the or each monitoring means being functionally connected to the flow regulating elements for individual control of the latter. Due to the design according to the invention, effective adjustment of the flow regulating elements is guaranteed. Due to the combination of controlled flow regulating elements on the one hand and monitoring means for the level within the tray and the hopper on the other hand, trouble-free discharge is ensured. Level regulation already within the tray and hence also within the discharge hopper as well as in the region of the channel allows uniform discharge of trays and shaft trays in a surprisingly simple manner.

An appropriate development of the invention provides that the flow regulating elements are variable in contour for varying the height of the channel in sections. Unlike the state of the art in which the flow regulating elements are movable as a whole, the flow regulating elements according to the invention are variable in themselves, namely variable in shape, by causing a change of volume e.g. by pulling them apart or pushing them together. Hence the product stream can be individually adjusted to the respective level.

Preferably the flow regulating elements include pivotable guide flaps. Due to the guide flaps on the one hand and their pivot capacity on the other hand, even better and more precise equalisation of the product stream within the discharge hopper is guaranteed, which optimises the discharge operation.

A preferred embodiment is characterised in that the monitoring means includes at least two sensor elements, but the number of sensor elements preferably corresponds to the number of shafts of a shaft tray to be discharged and the sensor elements are arranged in such a way that the level of each shaft can be determined separately. As a result, even more precise adjustment of the flow regulating elements is ensured, which reinforces the above-mentioned advantages still further.

A further appropriate embodiment is distinguished in that the filling hopper for each shaft of a shaft tray to be discharged comprises at least two sensor elements, the sensor elements being arranged one above or below the other. This embodiment likewise ensures reliable and uniform discharge due to optimised outflow of the product stream by means of level regulation in sections.

The object is also achieved by a method with the steps mentioned hereinbefore by the fact that the level within the tray or shaft tray is determined and the flow regulating elements are adjusted according to the level. The resulting advantages have already been described in connection with the apparatus, so that reference is made to the corresponding passages of the text to avoid repetition.

Further appropriate or advantageous features and developments as well as steps of the method are apparent from the subsidiary claims and the description.

### BRIEF DESCRIPTION OF THE DRAWINGS

Particularly preferred embodiments are described in more detail with the aid of the attached drawings. The drawings show:

FIG. 1 a front view of a first embodiment of a discharge hopper with no front wall, and

FIG. 2 a front view of a second embodiment of a discharge hopper with no front wall.

### BRIEF DESCRIPTION OF THE EMBODIMENTS

The discharge hoppers described serve to discharge trays or shaft trays filled with rod-shaped products.

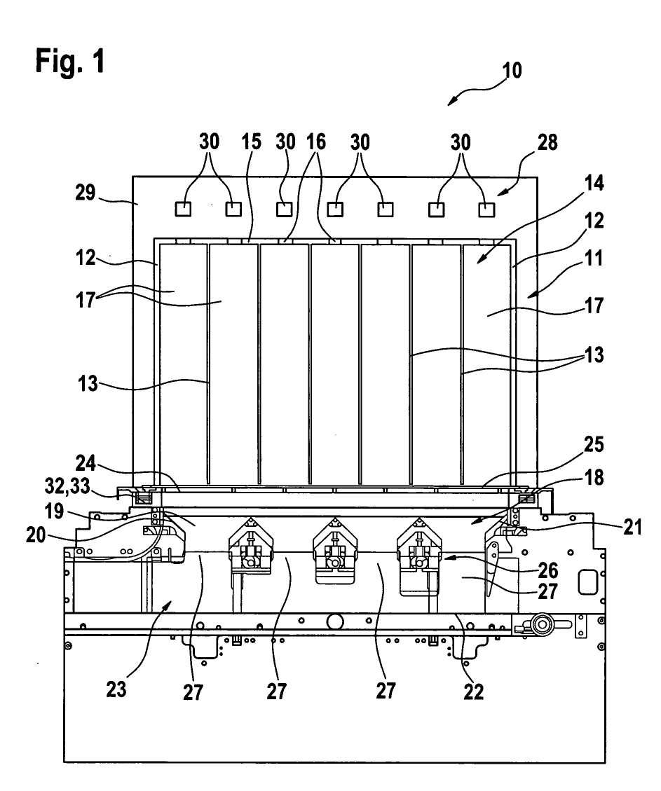

In FIG. 1 is shown a first embodiment of such a discharge hopper 10 which is designed to discharge shaft trays 11. The shaft tray 11 has side walls 12, shaft walls 13 running parallel to the side walls 12, a rear wall 14 and a bottom wall 15. The bottom wall can have openings 16 (see FIG. 1) or be at least partially transparent in order to allow monitoring means which are described below to detect the level within the shafts 17. The same applies to the rear wall 14. The discharge hopper 10 has a receiving chamber 18 which consists of a rear wall 19, a front wall which is not shown for reasons of greater clarity, and side walls 20, 21. At the bottom the receiving chamber 18 is defined by a conveying element 22 which can be driven in both directions and which is arranged at a distance from the receiving chamber 18 to form a channel 23. At the top in the direction of the shaft tray 11 the receiving chamber 18 is open.

A shaft tray 11 to be discharged is connected to the discharge hopper 10 by a connecting means 24 above the receiving chamber 18. The shaft tray 11 is upside down for the discharge operation. This means that the products within the shafts 17 lie on a closure element 25 opposite the bottom wall 15. The closure element 25 can in a known manner be e.g. a movable slide rail which is movable in a horizontal direction. The closure element 25 can furthermore form part of the discharge hopper 10, but also of a transfer device, not shown, for the full and empty shaft trays 11. The transfer device involves ordinary pivot devices or the like, on account of which drawing and description are dispensed with.

Within the receiving chamber 18 are arranged flow regulating elements 26 which serve to control the product stream within the discharge hopper 10. The flow regulating elements 26 are arranged stationarily within the receiving chamber 18, that is, they are not movable as a whole. However, the flow regulating elements 26 are variable in contour for varying the height of the channel 23 in sections. As can be seen from the figures, the flow regulating element 26 arranged on the left in the figures is pushed together, while the right flow regulating elements 26 is pulled apart. In other words, the flow regulating elements 26 are telescopically adjustable in length, wherein the lower movable section of the flow regulating element 26 has a slightly smaller width than the fixed section, and moves into the latter. Other embodiments such as for example a comb-like connection are also possible. For automation of displacement, the flow regulating elements 26 are preferably each assigned a drive (not shown). The displacement capacity may however also be realised in any other ordinary way. The capacity for adjusting the length in a vertical direction causes, on moving in or out, a change in the distance between the individual flow regulating elements 26 and the conveying element 22. Due to the altered distance, the cross-section of the channel 23 also alters automatically, so that the product stream can be directly influenced. Several such flow regulating elements 26 which are designed as displacers are arranged at a distance from each other within the receiving chamber 18, preferably in a lower region, and form vertically extending outlet shafts 27. The number and arrangement of flow regulating elements can of course vary. In the embodiments described, three displacers are provided, which together with the side walls 20, 21 form four outlet shafts 27. The outlet shafts 27 open in a funnel shape in the direction of the shaft tray 11 due to the design and arrangement of the side walls 20, 21 on the one hand and the flow regulating elements 26 on the other hand, which facilitates the product stream.

The discharge hopper 10 is further assigned a monitoring means 28. The monitoring means 28, which can be arranged e.g. on a frame 29 or the like of the discharge hopper 10, serves to detect the level of products within the tray or within the shafts 17 of the shaft tray 11. Preferably several sensor elements 30 which serve as monitoring means 28 are functionally connected to the flow regulating elements 26 for individual control of the latter. This functional connection can be made e.g. by a common control (not shown) or the like. The monitoring means 28 includes at least two sensor elements 30. Preferably, however, the number of sensor elements 30 corresponds to the number of outlet shafts 27. In the event that the discharge hopper 10 is designed to discharge shaft trays 11, the number of sensor elements 30 corresponds to the number of shafts 17 of the shaft tray 11. In this case the sensor elements 30 are arranged in such a way that the level of each shaft 17 can be determined separately. The arrangement can be selected differently.

In the embodiment according to FIG. 1 the sensor elements 30 are positioned above the shaft tray 11. To be more precise, above each shaft 17 is arranged a single sensor element 30. As mentioned above, the bottom wall 15 of the shaft tray 11 is prepared or designed in such a way that the current level within the shaft 17 can be determined. In an embodiment not shown explicitly, the sensor elements 30 are arranged behind or in front of the shafts 17, this being in such a way that the sensor elements 30 are directed at an angle obliquely from above onto the products within the shafts 17. In this case the level can be determined through the open front wall or, as described above, a rear wall 14 which is prepared or suitably designed.

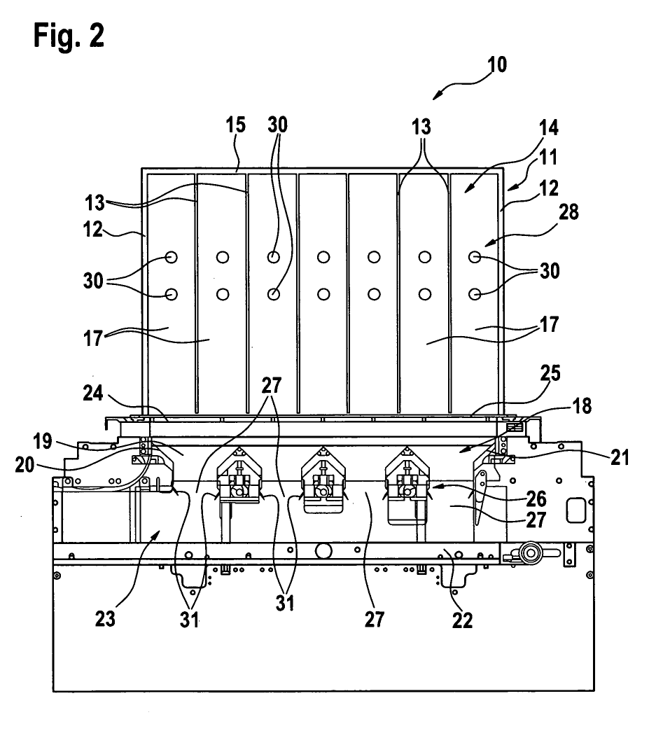

The embodiment as in FIG. 2 differs from the one shown in FIG. 1 essentially in that the sensor elements 30 are directed horizontally. Each shaft 17 of the shaft tray 11 is assigned at least two sensor elements 30 which are arranged one above or below the other. A further difference in the embodiment of FIG. 2 lies in that the flow regulating elements 26 include guide elements 31. These guide elements 31, which are designed as pivotable guide flaps, are designed and arranged for varying the cross-section of the outlet shafts 27. Here, each outlet shaft 27 on opposite sides is assigned two guide flaps which, controlled by the sensor elements 30, are pivotable about an axis out of a rest position (maximum cross-section of the outlet shafts) into a locking position (minimum cross-section of the outlet shafts) and vice versa. The shape and size of the guide flaps is variable. But preferably the guide flaps are designed in such a way that they do not completely close the outlet shafts 27 even in the locking position. The guide elements 31 can also be arranged on fixed walls of outlet shafts 27.

In addition to the monitoring means 28 already described, the discharge hopper 10 can be assigned at least one further monitoring means 32 which is arranged below the shaft tray 11 to be emptied and above the receiving chamber 18 of the filling hopper 10. The horizontally directed monitoring means 32, which can be e.g. a sensor element 33 as well, serves to detect the level of the receiving chamber 18. In particular, this prevents the shaft trays 11 from coming into contact with the products within the receiving chamber 18 when changing. All sensor elements 30, 33 are preferably designed as analogue optical photosensors. Other embodiments of the sensor elements 30, 33, e.g. as ultrasound sensors, etc., can be used as well.

The discharge hopper 10 can be used as a separate unit or as an (integral) part of a production line or assembly. Naturally the discharge hopper 10 is also suitable for emptying standard trays with a single receiving chamber. Lastly, the receiving chamber of a standard tray is also a (wide) shaft 17 which can be assigned the monitoring means 28.

Below, the principle of the method is described in more detail with the aid of the figures. A product-filled tray or shaft tray 11 is turned upside down or pivoted into the region of the connecting means 24 of the discharge hopper 10 in the usual manner, the products being held in the shaft tray 11 by the closure element 25. As soon as the closure element 25 is opened, the products drop into the receiving chamber 18 of the discharge hopper 10. The product stream is delivered through the receiving chamber 18 and through the outlet shafts 27 to the conveying element 22 which transports the product stream through the channel 23 out of the discharge hopper 10. During the discharge operation, the level in the tray or in each shaft 17 of the shaft tray is monitored, and the information obtained is used to control the flow regulating elements 26.

In other words, the flow regulating elements 26 are varied in contour, that is, increased or decreased, as a function of the respective levels within the shafts 17. Hence the channel 23 is varied in cross-section in sections, so that the level of the product stream is regulated in a horizontal direction. Alternatively or in addition, the cross-section of the outlet shafts 27 can also be varied by moving the guide elements 31. The movement of the guide elements 31 is also controlled by means of the information from the sensor elements 30 and regulates the product stream in a vertical direction. Due to the procedure described, uniform and reliable discharge of trays/shaft trays 11 is achieved, because in particular the individual shafts 17 of the shaft tray 11 dispense products uniformly. Product accumulation and/or an uneven level within the receiving chamber 18 of the discharge hopper 10 is thus avoided. In addition the level of the receiving chamber 18 can be monitored by the sensor elements 33, to prevent products from protruding upwards out of the receiving chamber 18 and so lying in the changing region of the shaft trays 11.

1. A discharge hopper for a tray discharge station for discharging a tray filled with rod-shaped products, comprising:
a receiving chamber for the products flowing from the tray, the receiving chamber having a top which is open in a direction of the tray and a bottom comprising a conveying element defining a channel for carrying away the products;
flow regulating elements located within the receiving chamber to control a flow of the products within the discharge hopper; and
a monitoring unit arranged and constructed to detect a level of products within the tray, the monitoring unit being operatively connected to the flow regulating elements for individual control of the regulating elements.

2. The discharge hopper according to claim 1, further comprising a control system connecting the monitoring unit and the flow regulating elements to each other.

3. The discharge hopper according to claim 1, wherein the flow regulating elements are fixed stationarily within the receiving chamber.

4. The discharge hopper according to claim 1, wherein the flow regulating elements have a variable contour to vary a cross-section of the channel in sections.

5. The discharge hopper according claim 1, wherein the flow regulating elements are moveable in and out telescopically in length in a vertical direction to vary a distance between a respective one of the flow regulating elements and the conveying element.

6. The discharge hopper according to claim 1, wherein a plurality of the flow regulating elements comprise displacers that are arranged within the receiving chamber to form vertically directed outlet shafts.

7. The discharge hopper according to claim 6, further comprising two outer side walls that define a width of the receiving chamber, wherein three displacers are arranged across the width of the receiving chamber between the two outer side walls to define four outlet shafts.

8. The discharge hopper according to claim 6, wherein the flow regulating elements include pivotable guide flaps.

9. The discharge hopper according to claim 8, wherein the guide flaps are arranged to vary a cross-section of the outlet shafts.

10. The discharge hopper according to claim 8, wherein at least two guide flaps are associated with each outlet shaft.

11. The discharge hopper according to claim 1, wherein the monitoring unit includes at least two sensor elements.

12. The discharge hopper according to claim 11, wherein the discharge tray includes a number of outlet shafts for containing the products, and the number of sensor elements corresponds to the number of outlet shafts.

13. The discharge hopper according to claim 11, wherein the tray includes a number of shafts for containing the products and the number of sensor elements corresponds to the number of shafts to be discharged, the sensor elements being arranged so that a level of the products in each shaft can be determined separately.

14. The discharge hopper according to claim 13, wherein the sensor elements are arranged above the shafts and are constructed so that the level of products in each shaft is determinable through suitably prepared walls of the tray.

15. The discharge hopper according to claim 12, wherein the tray includes a number of shafts for containing the products and the sensor elements are arranged in front of or behind the shafts so that the sensor elements are in each case directed at an angle obliquely from above onto the products within the shafts.

16. The discharge hopper according to claim 11, wherein the tray includes a number of shafts for containing the products and for each shaft at least two sensor elements are arranged one above or below the other.

17. The discharge hopper according to claim 11, further comprising at least one additional sensor element arranged below the tray to be discharged and above the receiving chamber of the hopper to detect a level of products in the receiving chamber.

18. The discharge hopper according to claim 17, wherein the at least one additional sensor element comprises an analogue optical photosensor.

19. A method for the discharge of a tray inserted in a discharge hopper and filled with rod-shaped products, the tray having a closed end that is openable, comprising steps of:
opening the closed end of the tray,
passing a flow of the product from the tray through a receiving chamber of the discharge hopper into a region of a conveying element;
regulating the product flow by flow regulating elements within the receiving chamber and in a region of a channel formed by the conveying element
carrying the product flow away along the channel;
determining a level of product within the tray; and
adjusting the flow regulating elements according to the level.

20. The method according to claim 19, wherein the tray includes a number of shafts containing the products, and wherein:
the determining step includes determining the level of products within each shaft and evaluating the levels by a control system; and
the adjusting step includes adjusting the flow regulating elements based on the results of the evaluating step.

21. The method according to claim 19, wherein the adjusting step includes automatically varying a contour of the flow regulating elements.

22. The method according to claim 19, wherein the adjusting step includes varying a cross-section of the channel in sections.

23. The method according to claim 19, wherein the receiving chamber has a width defined by side walls, and includes a number of outlet shafts defined by the side walls and the flow regulating elements, and the adjusting step includes varying a cross-section of the outlet shafts of the receiving chamber.
